(19) United States
(12) Patent Application Publication
(10) Pub. No.: US 2025/0030203 A1
(43) Pub. Date: Jan. 23, 2025

(54) ELECTRICAL CONNECTOR

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventor: MING-CHING CHEN, New Taipei (TW)

(21) Appl. No.: 18/775,276

(22) Filed: Jul. 17, 2024

(30) Foreign Application Priority Data
Jul. 19, 2023 (CN) 202310889564.4

(51) Int. Cl. H01R 13/6596; H01R 13/516; H01R 24/60

(52) U.S. Cl. CPC H01R 13/6596; H01R 13/516; H01R 24/60

(57) ABSTRACT

An electrical connector includes an insulative housing including a pair of side walls and a mating tongue located between the pair of side walls. Two sets of contacts are disposed at two opposite sides of the mating tongue, each set of contacts including plural differential-pair contacts and plural grounding contacts alternately arranged with each other along a transverse direction. A metallic ground bar is unitarily formed of a single piece and has a base connecting to the two sets of grounding contacts. A shielding member is secured to a center of the mating tongue and is electrically connected to the metallic ground bar.

### BACKGROUND OF THE INVENTION

### 1. Field of the Invention

The present invention relates to an electrical connector for high frequency transmission.

### 2. Description of Related Art

U.S. Pat. No. 9,509,098 discloses a connector including two rows of conductive terminals, and each row of conductive terminals includes signal terminals and ground terminals. The ground terminals in the two rows of conductive terminals are integrally connected to a ground tie bar to achieve common grounding.

It is desired to provide an electrical connector with an improved grounding member.

### SUMMARY OF THE INVENTION

An electrical connector comprises: an insulative housing including a pair of side walls, a mating tongue located between the pair of side walls, and a plurality of passageways formed in the mating tongue; a first set of contacts disposed in corresponding passageways at one side of the mating tongue and a second set of contacts disposed in corresponding passageways at the other side of the mating tongue, each set of contacts including a plurality of differential-pair contacts and a plurality of grounding contacts alternately arranged with each other along a transverse direction, each contact including a contacting section exposed to the mating tongue, a tail exposed outside of the housing, and a retaining section therebetween; a metallic ground bar unitarily formed of a single piece, the metallic ground bar including a base and the two sets of grounding contacts; and a shielding member secured to a center of the mating tongue and located between the two sets of contacts in a front-to-back direction and welded to the metallic ground bar.

Other advantages and novel features of the invention will become more apparent from the following detailed description of the present embodiment when taken in conjunction with the accompanying drawings.

### BRIEF DESCRIPTION OF THE DRAWINGS

FIG. 1 is a perspective view of a first embodiment of an electrical connector according to the invention;

FIG. 2 is another perspective view of the electrical connector of FIG. 1;

FIG. 3 is an exploded perspective view of the electrical connector of FIG. 1;

FIG. 4 is another exploded perspective view of the electrical connector of FIG. 1 wherein a shell is removed;

FIG. 5 is a perspective view of a base block and a grounding member of the electrical connector of FIG. 1;

FIG. 6 is an exploded perspective view of a mating block and the grounding member of the electrical connector of FIG. 1;

FIG. 7 is another exploded perspective view of the electrical connector of FIG. 6;

FIG. 8 is a perspective view of contacts and the grounding member of the electrical connector of FIG. 1;

FIG. 9 is a cross-sectional view of the electrical connector of FIG. 1 along line A-A to show positional relationship between a metallic ground bar, a shielding member and the grounding contacts;

FIG. 10 is a cross-sectional view of the electrical connector of FIG. 1 along line B-B to show positional relationship between a metallic ground bar, a shielding member and the differential-pair contacts;

FIG. 11 is a partial exploded perspective view of a second embodiment of an electrical connector according to the invention;

FIG. 12 is another partial exploded perspective view of the electrical connector of FIG. 11;

FIG. 13 is a perspective view of contacts and the grounding member of the electrical connector of FIG. 11;

FIG. 14 is a cross-sectional view of the electrical connector of FIG. 11 to show positional relationship between a metallic ground bar, a shielding member and the grounding contacts;

FIG. 15 is another cross-sectional view of the electrical connector of FIG. 11 to show positional relationship between a metallic ground bar, a shielding member and the differential-pair contacts;

FIG. 16 is a partial exploded perspective view of a third embodiment of an electrical connector according to the invention;

FIG. 17 is another partial exploded perspective view of the electrical connector of FIG. 16;

FIG. 18 a perspective view of contacts and the grounding member of the electrical connector of FIG. 16;

FIG. 19 is a cross-sectional view of the electrical connector of FIG. 16 to show positional relationship between a metallic ground bar, a shielding member and the grounding contacts; and

FIG. 20 is another cross-sectional view of the electrical connector of FIG. 16 to show positional relationship between a metallic ground bar, a shielding member and the differential-pair contacts.

### DETAILED DESCRIPTION OF THE PREFERRED EMBODIMENT

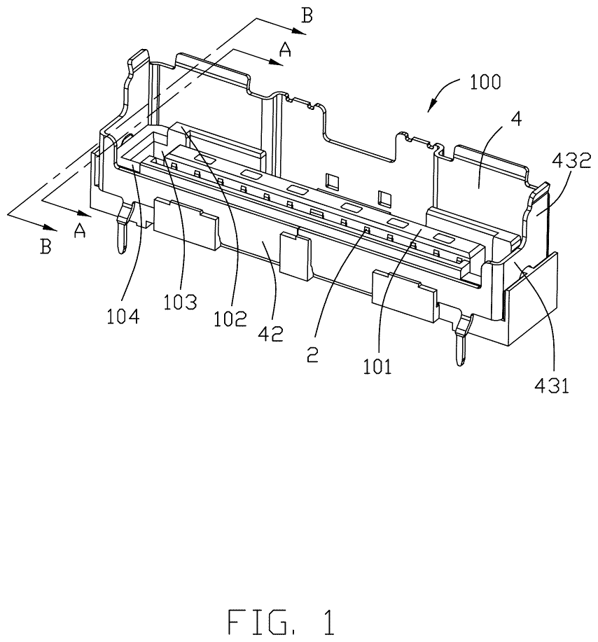

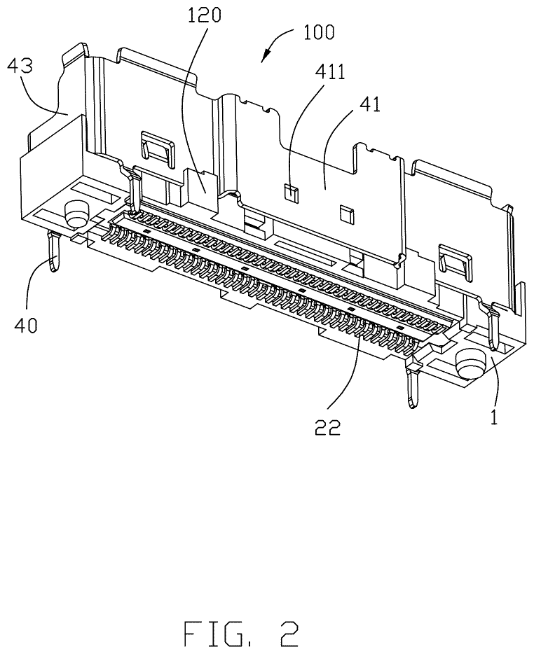

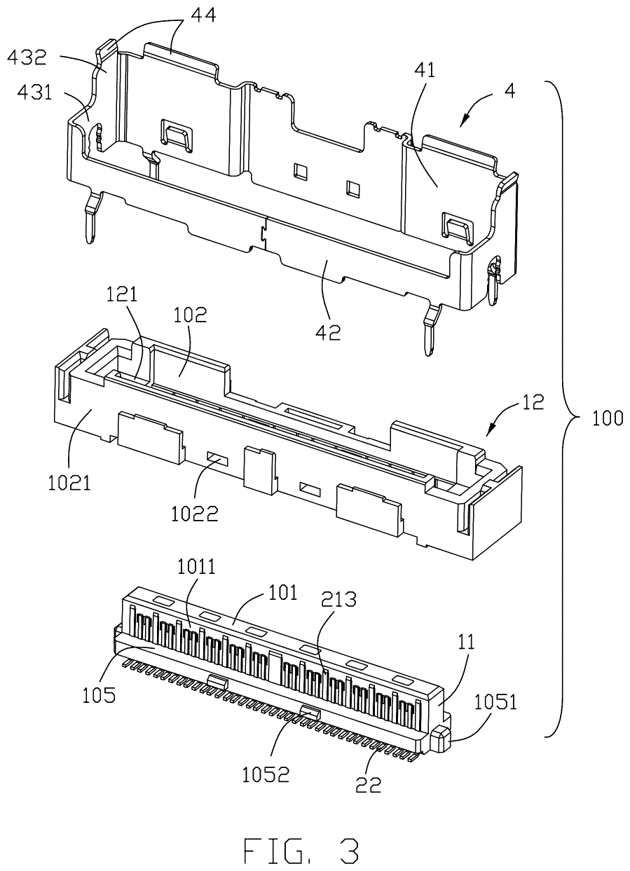

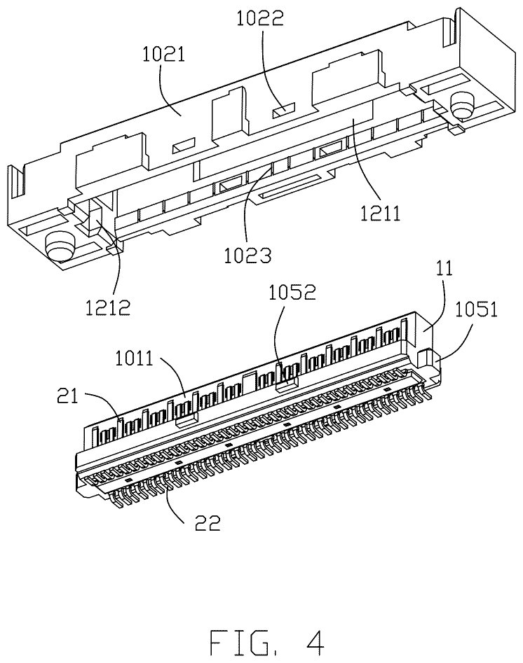

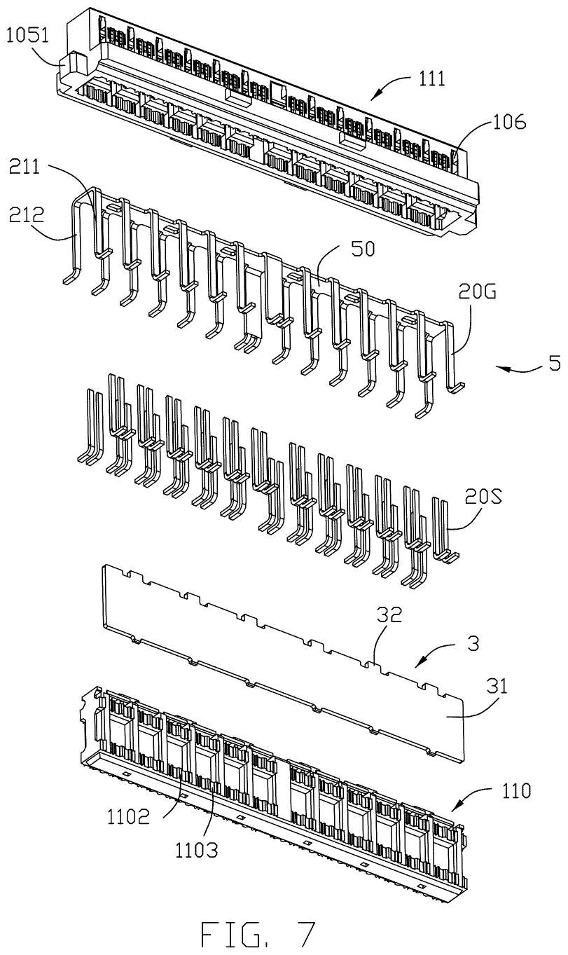

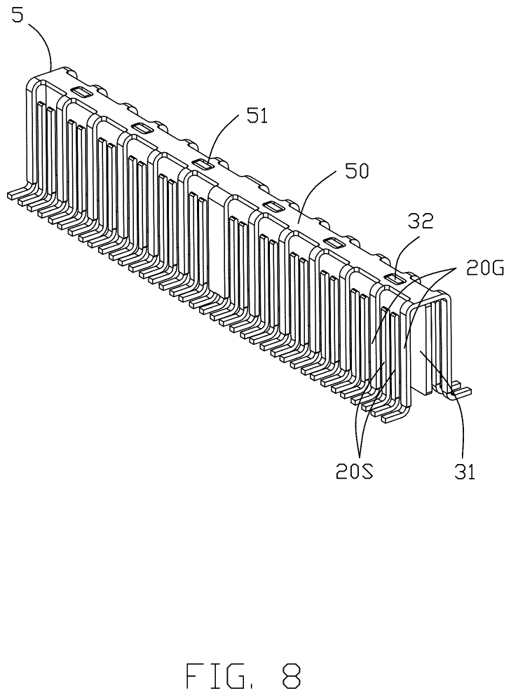

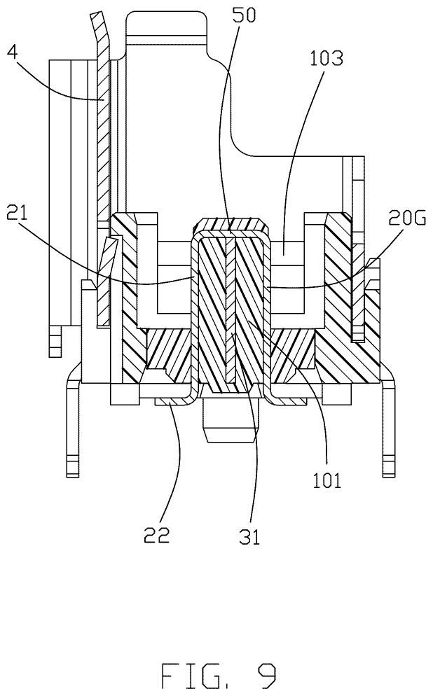

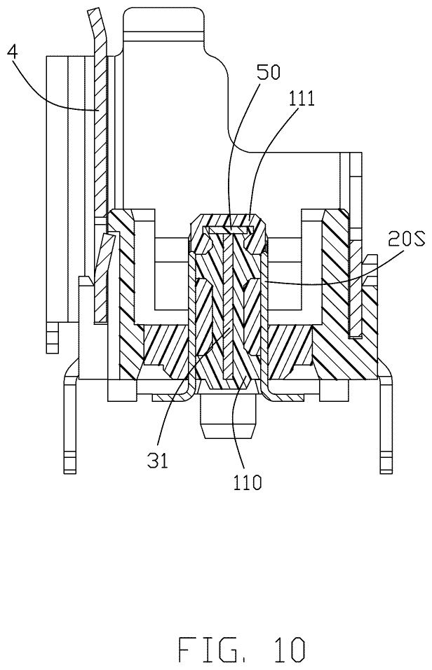

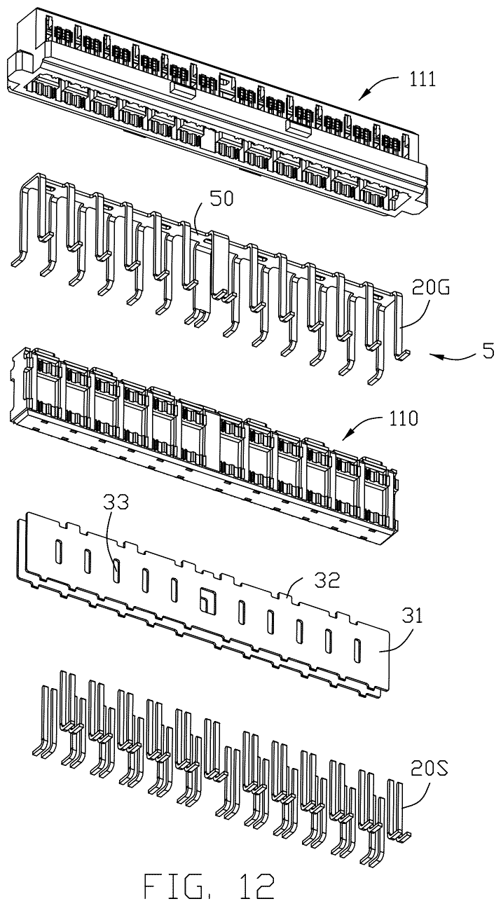

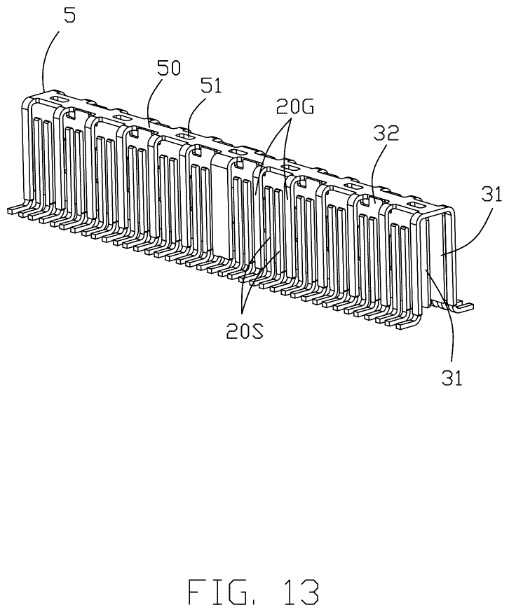

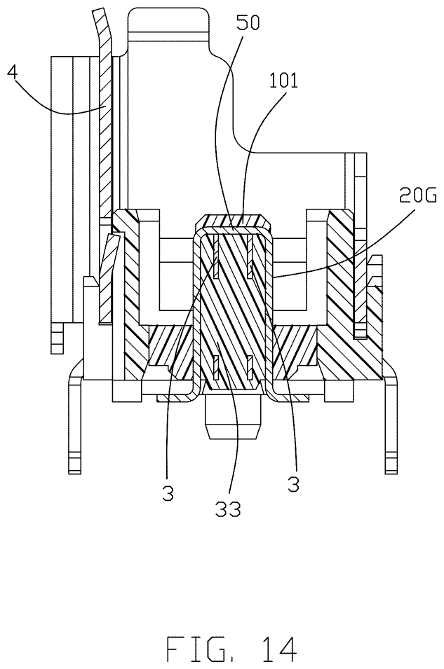

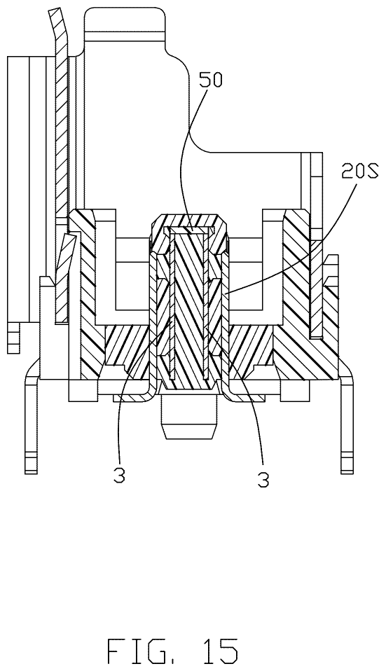

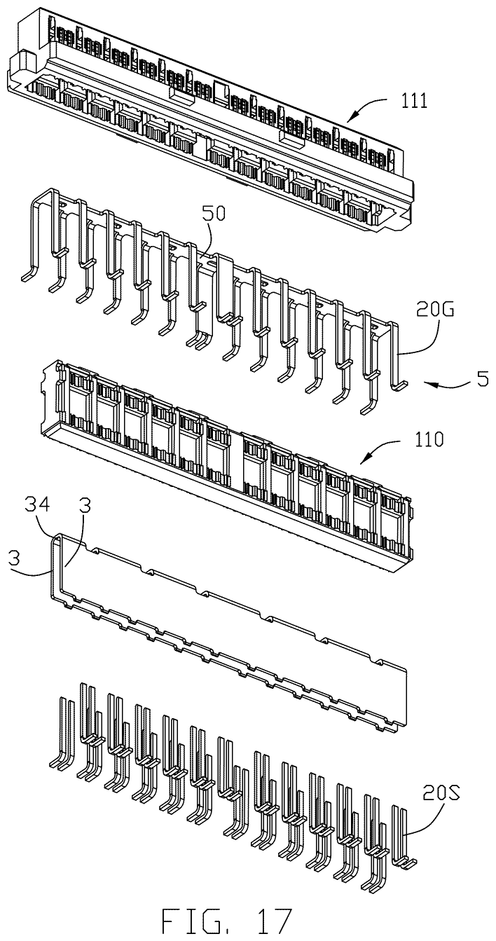

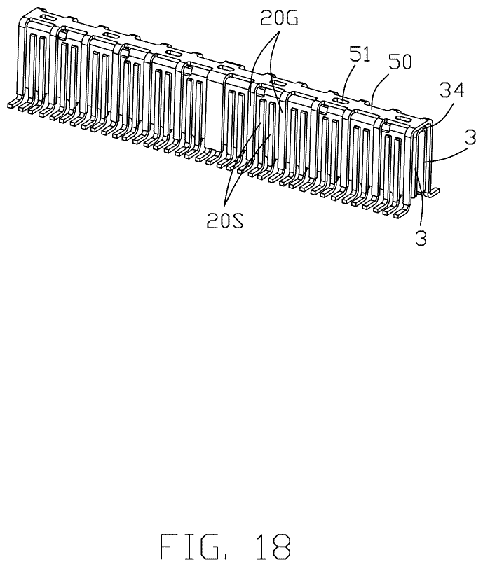

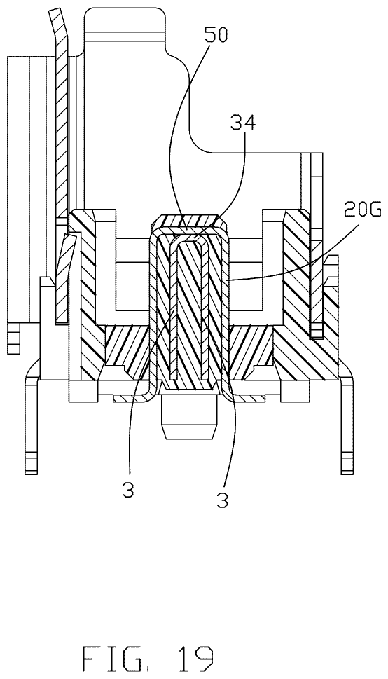

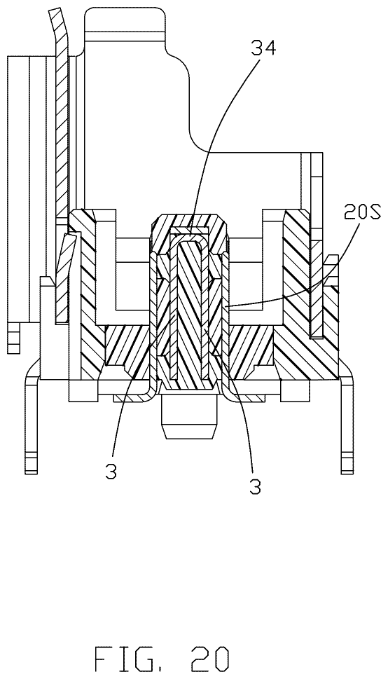

Referring to FIGS. 1-20, the present invention is an electrical connector 100 for high-speed signal transmission, which is installed on a circuit board (not shown). The electrical connector 100 is an FPIO connector.

The electrical connector 100 includes an insulative housing 1, two sets of contacts 2 fixed to the insulative housing 1, a shielding member 3 arranged between the two sets of contacts 2 in a front-to-back direction, and a metal shell 4 surrounding and fixed outside the insulative housing 1.

The insulative housing 1 includes a mating tongue 101 and a surrounding wall portion 102 which is formed by a pair of side walls 1021 and end walls surrounding the mating tongue 101. The surrounding wall portion 102 and the mating tongue 101 are spaced to form a cavity 103, and the cavity 103 penetrates through a mating surface 104 of the insulative housing 1 upwardly.

The shell 4 is mounted on the outside of the surrounding wall portion 102, extending upwardly in a vertical direction to exceed the mating surface 104 of the insulative housing 1. The shell 4 includes a first wall 41, a second wall 42 opposite to the first wall 41, and two opposite end walls 42 connecting the first wall 41 and the second wall 42. The first wall 41 of the shell 4 is provided with a locking hole 411, and the locking hole 411 is used for a locking arm (not shown) of the receptacle connector (not shown) to buckle in so as to complete the locking function. The lower ends of the first wall 41 and the second wall 42 extend downwardly to form a leg 40, and the leg 40 is welded to an external printed circuit board (not shown). The height of the second wall 42 of the shell 4 is lower than that of the first wall 41. The second wall 42 is roughly flush with the mating surface 104. Each end walls 43 are roughly two ladder-like distribution, including a first protrusion 431 protruding upwardly from a plane where the mating surface 104 is located, and a second protrusion 432 protruding upwardly from the plane. The second protrusion 432 is higher than the first protrusion 431. The two opposite ends of the second protrusion 432 in the vertical direction is roughly flush with the first wall 41. A part of the first protrusion 431 continues to connect to the second wall 42.

The second protrusion 432 and the first wall 41 further extend upwardly to form a plurality of guide pieces 44. The high and low structure of the shell 4 can better wrap the mating connector (not shown) therein, which not only has a good alignment effect, but also can ensure force balance. The outer side of the insulative housing 1 is provided with a plurality of retaining blocks 120. The metal shell 4 is inserted downwardly into a slit of the retaining block 120, which can fix the shell 4 well.

The insulative housing 1 includes a mating block 11 and a seat 12 assembled together, the mating block 11 including a mating tongue 101 and a mounting portion 105, the seat 12 including a bottom plate 121 and the surrounding wall portion 102, the bottom plate 121 provided with an opening 1211, the mating block 11 inserted into the opening 1211 from the bottom surface of the seat 12, and the mounting portion 105 of the mating block 11 is installed in the opening 1211 by clamping and interference, so that the mating block 11 and the seat 12 are assembled together to form the insulative housing 1. The mating tongue 101 further includes a plurality of passageways 106. The passageways 106 are formed in two opposite sides of the mating tongue 101 in the front-to-back direction so as to allow the contacts 2 to be exposed to the mating tongue 101. Two ends of the mounting portion 105 are provided with convex portions 1051 extending in a transverse direction, and the bottom surface of the bottom plate 121 is concavely formed upward to form a groove 1212, and the convex portion 1051 is fixed in the groove 1212 by interference, and the groove 1212 can limit the upward movement of the mating block 11 in the vertical direction. The mounting portion 105 has two protrusions to form a block portion 1052. Correspondingly, the side walls 1021 extending transversely of the surrounding wall portion 102 is provided with a holding hole 1022 for the block portion 1052 to be inserted into. The holding hole 1022 and the block portion 1052 cooperate to limit the movement of the mating block 11 in the vertical direction. In addition, the inner wall surface of the side wall 1021 is provided with a plurality of ribs 1023, which are used for interference fit with the lateral sides of the mounting portion 105.

Each contact includes a straight portion 21 and a tail 22 extending from the straight portion 21 out of the insulative housing 1. The straight portion 21 has an outer surface 211 and an inner surface 212 opposite to each other. The outer surface 211 is exposed to the insulative housing 1 to form a contacting section 213. The contacting section 213 is exposed to the contacting surface 1011 of the mating tongue 101. The tail 22 extends out of the insulative housing 1. In the present invention, each set of contacts 2 includes a signal contact 20S and a grounding contact 20G. In each set of contacts 2, two adjacent signal contacts 20S constitute a differential-pair contact. A plurality of differential-pair contacts and a plurality of grounding contacts 20G are alternately arranged with each other. A differential-pair contact has a grounding contact 20G on each lateral side. Compared with an upper end of the straight portion 21 of the signal contact 20S, an upper end of the straight portion 21 of the grounding contact 20G protrudes upward. In other words, the size in the vertical direction of the grounding contact 20G is greater than that of the signal terminal 20S, and the width of the straight portion 21 of the grounding contact 20G is also greater than the width of the straight portion 21 of the signal contact 20S.

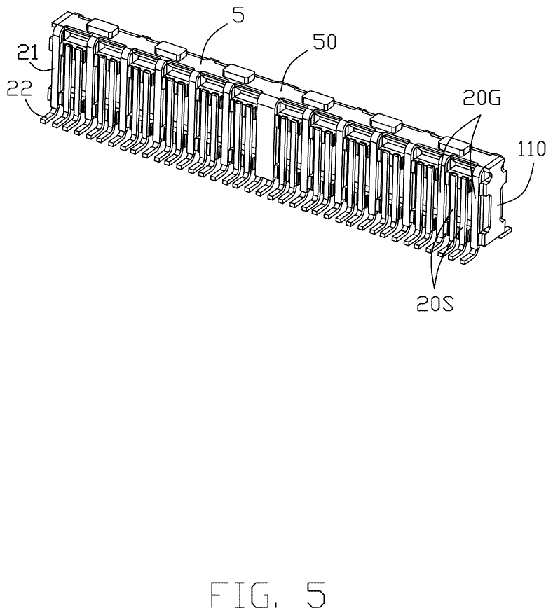

As shown in FIGS. 5-10, the shielding member 3 extends continuously and uninterruptedly in the transverse direction, and the shielding member 3 is used to reduce the signal crosstalk between the signal contact 20S in the two sets of contacts 2. All grounding contacts 20G in the two sets of contacts 2 are connected to each other through a base 50 to form a metallic ground bar 5, and the metallic ground bar 5 abuts against the shielding member 3. The two sets of contacts 2, the metallic ground bar 5, and the shielding member 3 are molded on the mating block 11. Specifically, the base 50 and the grounding contacts 20G in the two sets of contacts 2 are formed by stamping and bending a same metal plate, and the base 50 of metallic ground bar 5 is formed as a flat plate member extending in the transverse direction. The grounding contacts 20G in the two sets of contacts 2 are formed by bending downwardly from two opposite front and back sides of the base 50. In other words, the metallic ground bar 5 is unitarily formed of a single piece using the base 50 connecting to the upper end of the straight portion 21 of the grounding contacts 20G. The base 50 penetrates the upper and lower surfaces to form a plurality of holes 51 arranged in the transverse direction. The shielding member 3 includes a shielding plate 31 supporting the metallic ground bar 5 and a plurality of protrusions 32 protruding from the upper end of the shielding plate 31. The protrusions 32 are welded into the corresponding holes 51 so as to be electrically connected to the metallic ground bar 5.

The mating block 11 further includes a base block 110 and a covering block 111. The metallic ground bar 5 and the grounding contacts 20G in the two sets of contacts 2 integrally connected thereto are molded on the base block 110. When the base block 110 is injection molded, the insulative material will flow into the holes 51 to ensure a stable connection between the metallic ground bar 5 and the shielding member 3. The side surfaces 1100 of the base block 110 protrude in the front-to-back direction to form a plurality of positioning protrusions 1102 arranged at intervals along the transverse direction, and positioning grooves 1103 are formed between adjacent positioning protrusions 1102. The signal contacts 20S in the two sets of contacts 2 are fixed in the positioning grooves 1103, and the covering block 111 is injection molded outside the base block 110 to stabilize the signal contacts 20S.

The manufacturing method of the electrical connector 100 of the present invention will be described below. Provide a metal plate and stamp and bend the metal plate to form a metallic ground bar 5 and a plurality of grounding contacts 20G integrally connected to the front and rear sides of the base 50. Provide a shielding member 3 and weld the shielding member 3 to the metallic ground bar 5. Provide an insulative material and injection mold it outside the metallic ground bar 5 and the shielding member 3 to form a base block 110, and the grounding contacts 20G are located on the front and rear sides of the base block 110. Provide a plurality of signal contacts 20S, and set two signal contacts 20S as a pair between adjacent grounding contacts 20G, and the signal contacts 20S are fixed to the positioning grooves 1103 on both sides of the base block 110. Provide an insulative material and injection mold it outside the base block 110 to form a covering block 111. An insulative seat 12 is provided, and a mating block 11 consisting of a base block 110 and a covering block 111 is assembled from bottom to top through an opening 1211 of the seat 12 and fixed to the seat 12. A shell 4 is provided, and the shell 4 is assembled and fixed to the seat 12 from top to bottom to form the electrical connector 100.

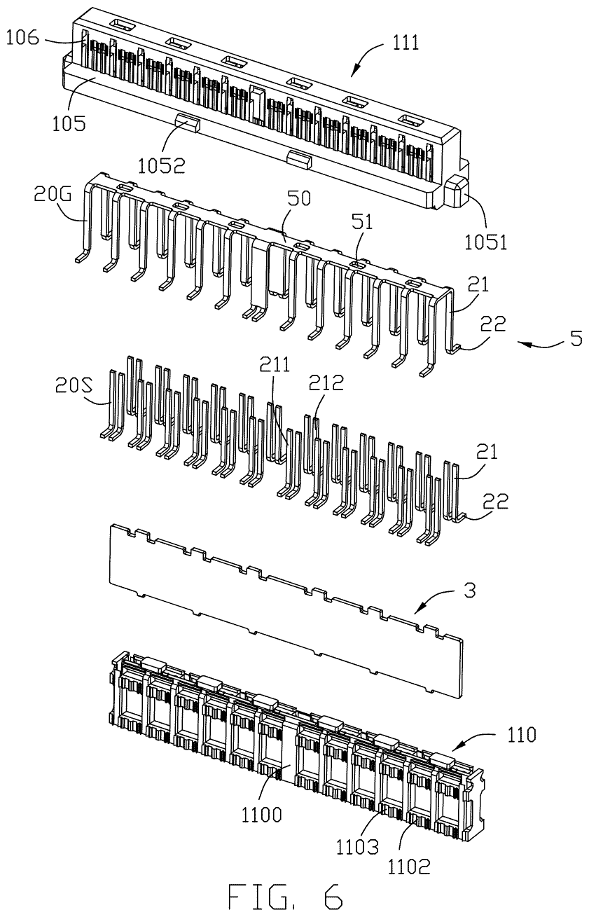

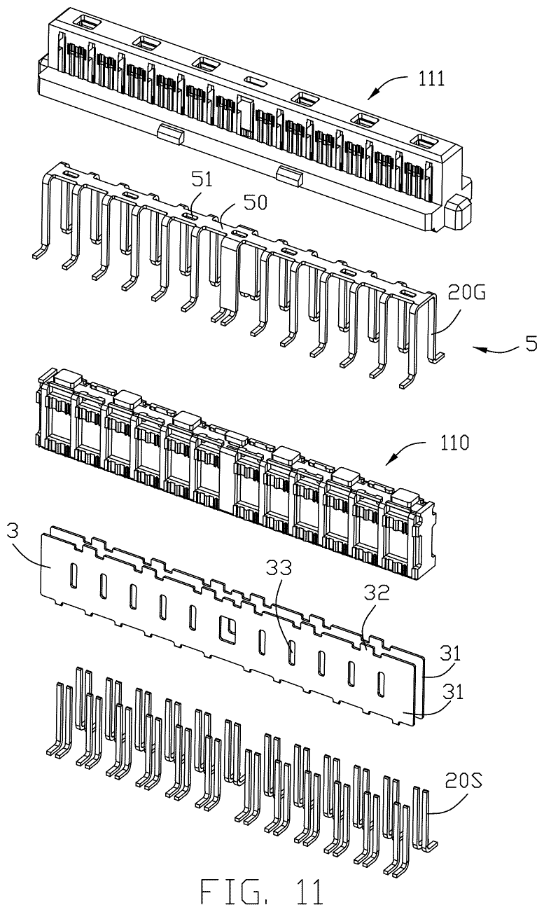

Referring to FIGS. 11-15, a second embodiment of the present invention is shown. Different from FIGS. 6 to 9 which include only one shielding plate 31, in the second embodiment, two shielding plates 31 are disposed between two sets of the contacts 2 in the front-to-back direction, and the two shielding plates 31 are spaced apart in the front-to-back direction and disposed independently of each other. Each of the shielding member 3 includes a shielding plate 31 and a protrusion 32 protruding upward from the upper end of the shielding plate 31. The shielding plates 31 of the two shielding member 3 respectively support the metallic ground bar 5, and the protrusion 32 are respectively welded and fixed to the front and rear sides of the metallic ground bar 5. Specifically, the protrusion 32 is welded and fixed in the area defined by the adjacent grounding contacts 20G on both front and rear sides of the metallic ground bar 5. In addition, in order to ensure that the base block 110 is reliably combined with the metallic ground bar 5, the metallic ground bar 5 is also provided with a hole 51, and the hole 51 is used for the insulative material of the base block 110 to flow into. Compared with the arrangement of one shielding plate, in the second embodiment, two shielding members 3 are spaced in the front-to-back direction. Thus, the spacing between the contacts 2 and the shielding member 3 can be adaptively adjusted, thereby effectively providing high-frequency performance of the electrical connector 100. In addition, in the second embodiment, the two shielding members 3 are provided with through openings 33 at the corresponding grounding contacts 20G and are closed at the corresponding signal contacts 20S. The through openings 33 allow the insulative material of the base block 110 to flow in during injection molding, thereby ensuring the reliability of the combination between the shielding members 3 and the base block 110.

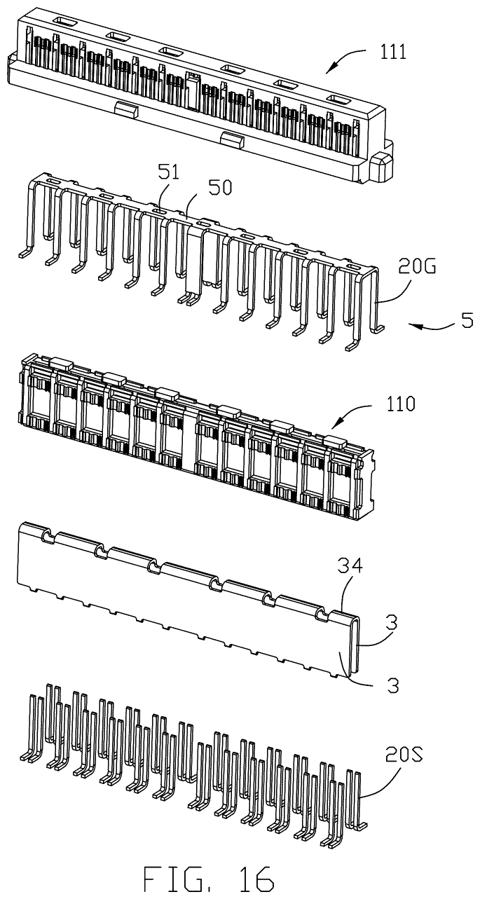

Referring to FIGS. 16-20, a third embodiment of the present invention is shown. Different from the second embodiment, in the third embodiment, the upper ends of two shielding members 3 are integrally connected via a top plate 34, and the top plate 34 is horizontally arranged and welded to the lower surface of the metallic ground bar 5. The metallic ground bar 5 is also provided with a plurality of holes 51, and the holes 51 are used for the insulative material of the base block 110 to flow into.

In the electrical connector 100 of the present invention, the grounding contacts 20G of the two sets of contacts 2 are integrally connected to each other through a metallic ground bar 5, and the metallic ground bar 5 is welded and fixed to the metal shielding member 3. The grounding contact 20G and the shielding member 3 are reliably and electrically connected and have good high-frequency performance. In addition, the integrated structure of the metallic ground bar 5 and the grounding contact 20G has high structural strength, which can effectively prevent the electrical connector 100 from warping due to heat.

Although the present invention has been described with reference to particular embodiments, it is not to be construed as being limited thereto. Various alterations and modifications can be made to the embodiments without in any way departing from the scope or spirit of the present invention as defined in the appended claims.

1. An electrical connector comprising:
an insulative housing including a pair of side walls, a mating tongue located between the pair of side walls, and a plurality of passageways formed in the mating tongue;
a first set of contacts disposed in corresponding passageways at one side of the mating tongue and a second set of contacts disposed in corresponding passageways at the other side of the mating tongue, each set of contacts including a plurality of differential-pair contacts and a plurality of grounding contacts alternately arranged with each other along a transverse direction, each contact including a contacting section exposed to the mating tongue, a tail exposed outside of the housing, and a retaining section therebetween;
a metallic ground bar unitarily formed of a single piece, the metallic ground bar including a base and the two sets of grounding contacts; and
a shielding member secured to a center of the mating tongue and located between the two sets of contacts in a front-to-back direction and welded to the metallic ground bar.

2. The electrical connector as claimed in claim 1, wherein the base is formed as a flat plate member, the two sets of grounding contacts bending and extending downwardly from two opposite edges of the base.

3. The electrical connector as claimed in claim 1, wherein each contact includes a straight portion extending along a vertical direction and the tail extends from the straight portion, the straight portion having an outer surface exposed upon the mating tongue, the contacting section formed on the outer surface of the straight portion, the grounding contacts connected to the base via an upper end of the straight portion.

4. The electrical connector as claimed in claim 1, wherein the metallic ground bar further includes a plurality of holes arranged along the transverse direction, each hole penetrating an upper surface and a lower surface of the base, the shielding member including a shielding plate and a plurality of protrusions extending from an upper end of the shielding plate to be welded to corresponding holes.

5. The electrical connector as claimed in claim 1, wherein the shielding member has two opposite shielding plates spaced from each other in the front-to-back direction, each shielding plate including a plurality of protrusions extending from an upper end of the shielding plate to be welded to opposite front and back sides of the base respectively.

6. The electrical connector as claimed in claim 5, wherein each shielding plate is provided with a plurality of through holes at a position corresponding to the grounding contact.

7. The electrical connector as claimed in claim 1, wherein the shielding member has two opposite shielding plates spaced from each other in the front-to-back direction, and the two opposite shielding plates are connected by a top plate to be welded to a lower surface of the base.

8. The electrical connector as claimed in claim 1, wherein the insulative housing includes a mating block and a seat, the two sets of contacts, the metallic ground bar, and the shielding member are insert-molded with the mating block, the mating block includes the mating tongue and a mounting portion, the seat further includes a bottom plate and a surrounding wall portion formed by a pair of side walls and end walls, the bottom plate is provided with an opening which the mounting portion is fixed in, the mating tongue is located in the surrounding wall portion, and a cavity is formed between the mating tongue and the surrounding wall portion.

9. The electrical connector as claimed in claim 8, wherein the mating block further includes a base block and a covering block, the metallic ground bar, the grounding contacts, and the shielding member are insert-molded with the base block, a plurality of extension portions extend outwardly from two opposite surfaces of the base block in a front-to-back direction perpendicular to the transverse direction and are arranged at intervals along the transverse direction, a respective positioning slot is formed between every two adjacent extension portions, differential-pair contacts are fixed in a corresponding positioning slot, and the covering block is molded outside the base block.

10. The electrical connector as claimed in claim 1, wherein a first size of the grounding contacts in a vertical direction is greater than a second size of the differential-pair contacts in the vertical direction.

11. An electrical connector comprising:
an insulative housing including a pair of side walls, a mating tongue located between the pair of side walls, and a plurality of passageways formed in the mating tongue;
a first set of differential-pair contacts disposed in corresponding passageways at one side of the mating tongue, each differential-pair contact including a contacting section exposed upon one face of the mating tongue, a tail exposed outside of the housing, and a retaining section therebetween;
a metallic ground bar being unitarily formed of a single piece and secured to the mating tongue, the metallic ground bar including a base and a first set of grounding contacts extending from the base, the first set of grounding contacts disposed in corresponding passageways; and
a shielding member secured to the mating tongue, located between two sets of differential-pair contacts in a front-to-back direction, and welded to the metallic ground bar, the shielding member including a shielding plate.

12. The electrical connector as claimed in claim 11, wherein each grounding contact includes a contacting section exposed upon one face of the mating tongue, a tail exposed outside of the housing, and a retaining section therebetween,

13. The electrical connector as claimed in claim 11, wherein a first size of the grounding contacts in a vertical direction is greater than a second size of the differential-pair contacts in the vertical direction.

14. The electrical connector as claimed in claim 11, wherein one of the grounding contacts is broader than the other grounding contacts in the transverse direction.

15. The electrical connector as claimed in claim 11, further including a second set of differential-pair contacts disposed in corresponding passageways at the other side, the metallic ground bar further includes a second set of grounding contacts extending from the base, and the two sets of grounding contacts are exposed upon two opposite faces of the mating tongue.

16. The electrical connector as claimed in claim 15, wherein the shielding member includes two parallel shielding plates secured to the mating tongue.

17. A grounding member for use within an electrical connector having a mating tongue, said grounding member comprising:
a metallic ground bar including a base formed as a flat plate member and two sets of grounding contacts extending downwardly from opposite front and rear ends of the base; and
a shielding member welded to the metallic ground bar; wherein
each grounding contact includes a straight portion extending along a vertical direction to connect to the base and a tail extending from the straight portion, and the shielding member includes a shielding plate located between the two sets of grounding contacts in a front-to-back direction.

18. The grounding member as claimed in claim 17, wherein the metallic ground bar further includes a plurality of holes arranged along a transverse direction, each hole penetrating both an upper surface and a lower surface of the base, the shielding member including a shielding plate and a plurality of protrusions extending from an upper end of the shielding plate to be welded to corresponding holes.

19. The grounding member as claimed in claim 17, wherein the shielding member has two opposite shielding plates spaced from each other in a front-to-back direction, the two shielding plates each including a plurality of protrusions extending from a respective upper end thereof to be welded to opposite front and back sides of the base respectively.

20. The grounding member as claimed in claim 17, wherein the shielding member has two opposite shielding plates spaced from each other in a front-to-back direction, and the two opposite shielding plates are connected by a top plate to be welded to a lower surface of the base.
